(19) United States
(12) Patent Application Publication
(10) Pub. No.: US 2025/0330774 A1
(43) Pub. Date: Oct. 23, 2025

(54) SYSTEM FOR ADJUSTING A PHYSICAL ROUTE BASED ON REAL-TIME CONNECTIVITY DATA

(71) Applicant: Telefonaktiebolaget LM Ericsson (publ), Stockholm (SE)

(72) Inventors: Gyan RANJAN, Milpitas, CA (US); Arthur Richard BRISEBOIS, Westport Point, MA (US); Alejandro Gil CASTELLANOS, Snoqualmie, WA (US)

(21) Appl. No.: 18/864,652

(22) PCT Filed: Apr. 25, 2023
(86) PCT No.: PCT/IB2023/054231

§ 371 Date: Nov. 11, 2024

Related U.S. Application Data
(60) Provisional application No. 63/341,890, filed on May 13, 2022.

(51) Int. Cl. H04W 4/024; H04B 17/391; H04W 64/00

(52) U.S. Cl. CPC H04W 4/024; H04B 17/3913; H04W 64/006

(57) ABSTRACT

A system configured to manage physical routes associated with one or more communication devices. The system determines information associated with a performance of a communication network connecting a first communication device with a second communication device as the first communication device moves along a physical route. The system, responsive to determining the information, determines instructions for improving a connection between the first communication device and the second communication device. The system provides an indication of the instructions to the first communication device.

### TECHNICAL FIELD

The present disclosure is related to wireless communication systems and more particularly to a system for adjusting a physical route based upon real-time connectivity data.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

Remotely operated vehicle (“ROV”) examples are used in the descriptions that follow, but actual use cases can go beyond ROVs, to include any case where a lack of content/context awareness can reduce the efficacy of intent-based network and application behavior controls.

ROVs can depend upon ultra-reliable low latency communications (“URLLC”) links between vehicles and remote operators. Autonomous vehicles (“AV”) can also require URLLC links and remote operators when/if the vehicle encounters construction or other unexpected conditions it is unable to handle autonomously. These vehicles stream video and sensor data towards remote operators over URLLC bearers. Remote operators send control information (e.g., steering and braking) back to the vehicle over URLLC bearers. Late and/or missing vehicle-to-operator video frames impact awareness and ability of a remote operator to avoid collisions.

According to the National Highway Traffic Safety Administration (“NHTSA”), the affect perception-reaction time and speed have on a driver's capability can be illustrated by braking. The average driver requires approximately 1.5 seconds to perceive, react, and apply the brakes. During this 1.5 seconds, the brakes are not being applied, the vehicle is continuing to move at the same speed, and the vehicle is continuing along the same path toward the hazard. As per the NHTSA illustration in FIG. 2, a human driver and vehicle moving 60 mph may travel nearly 132 feet within this 1.5 second reaction time interval. In some examples, the human controller can be replaced with an electromechanical controller (e.g., with sensors (instead of eyes), a processor (instead of a brain), and an actuator (instead of a leg) that are connected by an extremely low latency neurological system).

In the remotely operated vehicle case, there are additional processing and transportation nodes and delays between the sensors in the vehicle, brain in the remote operator, and actuators in the vehicle. Images can be processed and transported over a radio access network (“RAN”) between the vehicle and operator. Likewise, control signals can transported over the RAN network between the operator and the vehicle. The round-trip time of these radio links is added to the 1.5 second reaction time of the remote operator. A second of radio lag may be insignificant to mobile phone browsers. At 60 Mph, each additional second of round-trip radio time adds approximately 88 feet to the distance travelled before braking (and therefore deceleration) has even begun.

### SUMMARY

According to some embodiments, a method of operating a system configured to manage physical routes associated with one or more communication devices is provided. The method includes determining information associated with a performance of a communication network connecting a first communication device with a second communication device as the first communication device moves along a physical route. The method further includes, responsive to determining the information, determining instructions for improving a connection between the first communication device and the second communication device. The method further includes providing an indication of the instructions to the first communication device.

According to other embodiments, a communication device, a network node, a system, a host, a computer program, a computer program code, and a non-transitory computer readable medium is provided to perform at least one of the above methods.

Certain embodiments may provide one or more of the following technical advantages. In some embodiments, the procedure reduces the risk of lost connectivity for AV/ROV, without dependence on massive radio network capacity and/or coverage and data feed upgrades. Some embodiments are able to improve connectivity reliability, even in multi-CSP network and multi-SIM AV/ROV scenarios where network performance data, predictions, and control are sparse or unavailable. Additional or alternative embodiments are aware of, and adaptive to, real-world and real-time connectivity issues which may not be predictable. Additional or alternative embodiments leverage distributed data sources and processing, and shall therefore improve with AV/ROV number and range expansion.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a graph illustrating an example of a total stopping distance of vehicles at different speeds based on driver perception-reaction time;

FIG. 3 is a schematic diagram illustrating an example of a system response time and its components;

FIGS. 4-7 are block diagrams illustrating an example of a system for adjusting a physical route based on real-time connectivity data in accordance with some embodiments;

FIG. 8 is a schematic diagram illustrating an example of a ROV moving along a first physical route in accordance with some embodiments;

FIG. 9 is a schematic diagram illustrating an example of the ROV of FIG. 10 and a second physical route intended to improve a connection of the ROV due to in accordance with some embodiments;

FIG. 10 is a schematic diagram illustrating an example of a third physical route based on the connection of the ROV in FIG. 11 in accordance with some embodiments;

FIG. 11 is a flow chart illustrating an example of operations performed by a system in accordance with some embodiments;

FIG. 12 is a block diagram of a communication system in accordance with some embodiments;

FIG. 13 is a block diagram of a user equipment in accordance with some embodiments;

FIG. 14 is a block diagram of a network node in accordance with some embodiments;

FIG. 15 is a block diagram of a host computer communicating with a user equipment in accordance with some embodiments;

FIG. 16 is a block diagram of a virtualization environment in accordance with some embodiments; and

FIG. 17 is a block diagram of a host computer communicating via a base station with a user equipment over a partially wireless connection in accordance with some embodiments in accordance with some embodiments.

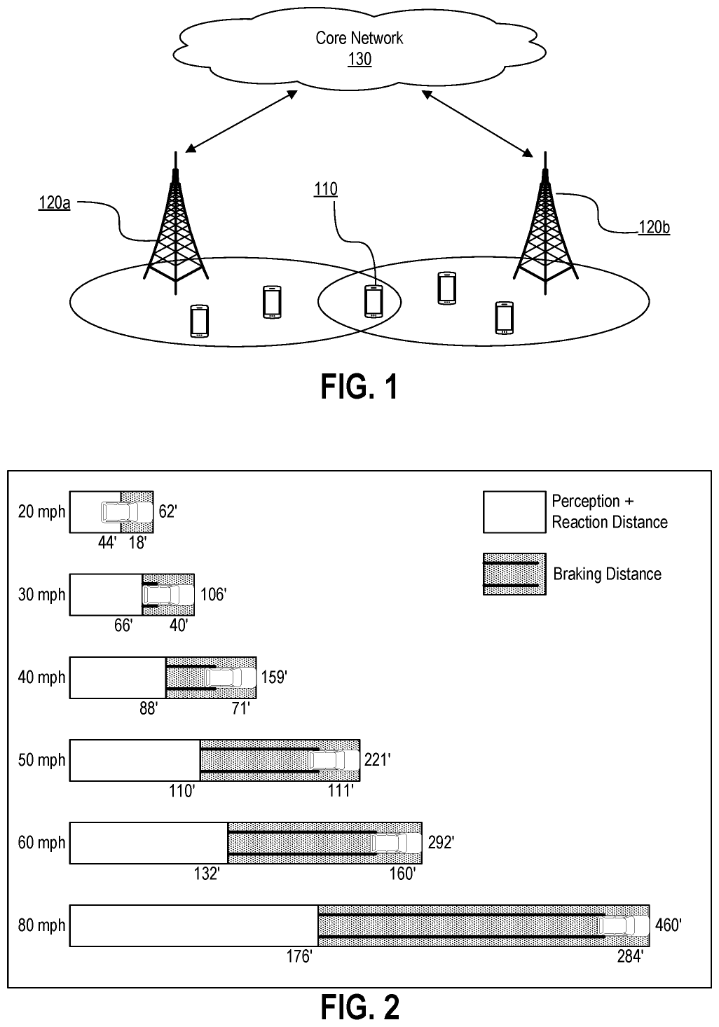

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

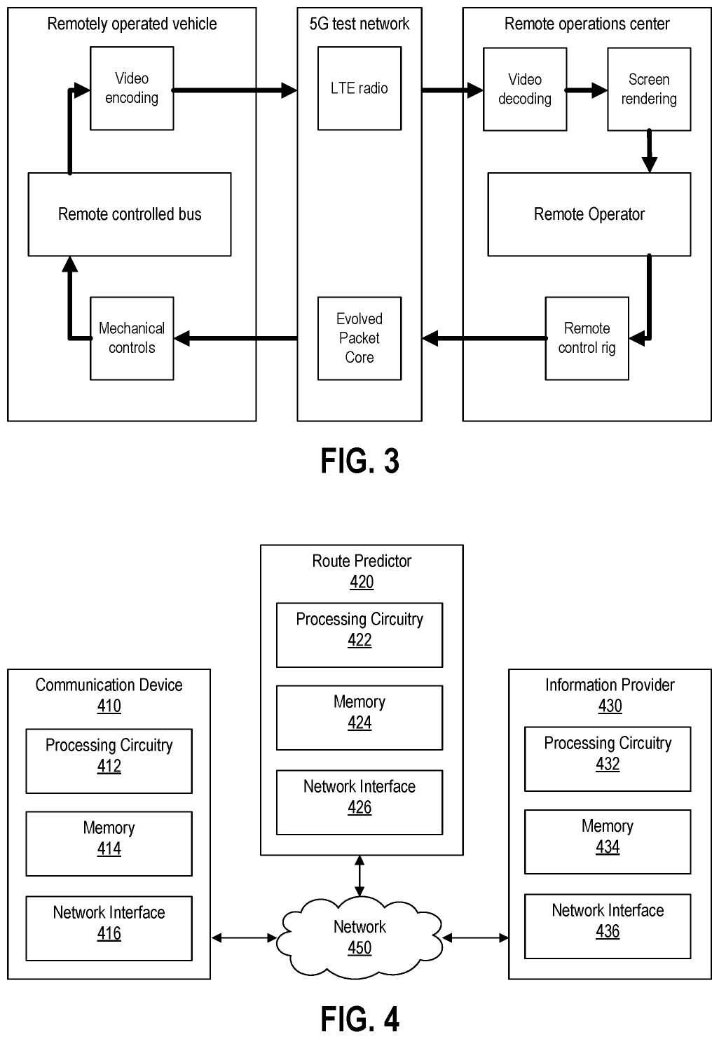

FIG. 3 illustrates an example of system response time and its components. In this case, the true intent of the AV/ROV customer is not some throughput target measured over time. The true intent is to minimize, or at least proactively adjust to, instantaneous round trip radio time between the vehicle cameras, sensors, and the remote operator terminal, in order to ensure safety wherever and whenever the ROV/AV travel.

Traditional quality of service (“QoS”) and intent-based network tuning mechanisms are used to prioritize network resource allocations for the AV/ROV assigned to URLCC bearers.

There currently exist certain challenges. Some systems designed to improve the reliability of ROV connectivity are focused upon maintenance of minimum service level agreement (“SLA”) link performance targets wherever and whenever the AV/ROV travels within a single network. In these examples, the true intent, reliable connectivity for safety, is converted to a network bearer performance target, for example uplink throughput. As the AV/ROV travels from point A to point B, every network node, including and especially radio cell sites, will work harder to maintain these minimum performance targets for the AV/ROV modem. In some examples, “working harder” entails use of relative resource allocation ratios to assign more resources to AV/ROV URLLC bearers versus “best effort” bearers assigned to other devices and applications sharing the same network. In some examples, the Zero Sum Game approach is used to remove or preempt some resources from non-URLLC bearers (e.g., smartphones), in order to assign more resources to URLLC bearers (e.g., an AV/ROV).

In some examples, these systems reliably deliver average performance gains for URLLC versus best-effort bearers, but they fail to guarantee reliable connectivity under some of the most safety-critical scenarios encountered by human and AV/ROV drivers and vehicles.

In some examples, existing QoS mechanisms are ineffective when vehicle transmitter power is limited. One of the most critical, yet vulnerable, communications link in the ROV to operator control loop is the uplink radio path used to stream video from the vehicle to the operator. Encoded video packets are sent from the vehicle transmitter to the cell site receiver. Successful reception, of this relatively high rate bit stream can require a relatively high signal to noise ratio (“SNR”) at the cell site receiver. Distance and objects, between the vehicle transmitter and cell site receiver, increase the amount of vehicle transmitter power required to achieve the necessary SNR. Vehicle transmitter power is limited for a variety of reasons including radiation safety and interference. Current cellular networks are uplink coverage and power constrained, and the AV/ROV economics are unlikely to support massive network coverage enhancements to close these gaps. Existing network QoS mechanisms can influence the relative amount of network resources allocated to AV/ROV versus other devices, but they have no influence over absolute coverage and transmitter power limitations of the vehicle modem. In some examples, network QoS mechanisms have little to no effect on uplink performance when distance and objects demand more uplink transmitter power than the vehicle can deliver.

In additional or alternative examples, existing radio QoS mechanisms are ineffective where AV/ROV population is high. Prior to the emergence of AV/ROV, most cellular network traffic was very downlink-heavy. High video consumption, at mobile smartphone devices, has contributed to an approximately 10 to 1 ratio of downlink versus uplink cellular network data traffic. Cellular networks have been engineered for these traditional traffic ratios. For example, many time division duplex (“TDD”) cellular radios allocate 3-8 times as many subframes (time slices) for downlink transmission to devices versus uplink reception from devices. Current cellular networks are uplink capacity constrained, and the AV/ROV economics are unlikely to support massive capacity shift away from the majority downlink smartphone needs. When and where AV/ROV populations are sparse, existing QoS mechanisms will successfully allocate a larger portion of uplink resources taken away from smartphones and other non-URLLC devices. This uplink capacity constraint will become unmanageable when a high portion of the device population are AV/ROV URLLC devices competing for their equal share of limited uplink resources. Construction, accidents, and AV/ROV traffic jam zones are example where no amount of QoS prioritization can overcome unplanned uplink resource supply/demand mismatches.

Certain aspects of the disclosure and their embodiments may provide solutions to these or other challenges. In some embodiments, an AV/ROV can be physically routed away from unpredictable and unsolve-able network connectivity issues. In some examples, unpredictable network connectivity issues are reported by an AV/ROV. In additional or alternative examples, unpredictable network connectivity issues are discovered by analysis of network-sourced call trace record (“CTR”), fault management (“FM”), and performance management (“PM”) data reported by a network node. A node can provide real-time and proactive road segment and network selection recommendations that avoid explicitly-reported connectivity gaps based on the real-time data from the AV/ROV and/or network node.

In some embodiments, a node (e.g., a route predictor) can receive real-time information about a connection between a communication device (e.g., an AV/ROV) and an information provider (e.g., a remote operator) while the communication device is moving along a physical route (sometimes referred to herein as a “route”). The node can use the information to identify route segments of the physical route with reduced connectivity and to classify the road segment based on how long the reduced connectivity will occur. In additional or alternative embodiments, the node determines whether the communication device should take a different physical route or switch to a different communications network. In additional or alternative embodiments, the node determines whether other communication devices should change their physical routes or associated communications networks.

Certain embodiments may provide one or more of the following technical advantages. In some embodiments, the procedure reduces the risk of lost connectivity for AV/ROV, without dependence on massive radio network capacity and/or coverage and data feed upgrades. Some embodiments are able to improve connectivity reliability, even in multi-CSP network and multi-SIM AV/ROV scenarios where network performance data, predictions, and control are sparse or unavailable. Additional or alternative embodiments are aware of, and adaptive to, real-world and real-time connectivity issues which may not be predictable. Additional or alternative embodiments leverage distributed data sources and processing, and shall therefore improve with AV/ROV number and range expansion.

Various embodiments herein use real-time data (e.g., data from an autonomous (“AV”)/remote operated vehicle (“ROV”) or live network data feeds) to improve a communication device (e.g., an AV/ROV) connectivity in cases where network data, control, and improvement options may be sparse, outdated, inadequate, or completely unavailable and/or in cases where best efforts may not satisfy the communication device connectivity intent. In some embodiments, communication device “crowd sourced” data are used to detect and avoid the obstacles before or while they are being fixed. In additional or alternative embodiments, communication service provider (“CSP”)-agile capabilities are added that steer multi-subscriber identity module (“SIM”) communication devices towards the network with the least connectivity issues.

FIG. 4-7 illustrate examples of a system configured to adjust a physical route based on real-time connectivity data.

FIG. 4 illustrates an example of a system that includes at least one of a communication device 410, route predictor 420, and information provider 430 communicatively coupled by a network 450. In some embodiments, the communication device 410 includes an AV/ROV and the information provider 430 includes a remote operator.

In this example, the communication device 410 includes processing circuitry 412, memory 414, and a network interface 416. The memory 414 can include instructions that are executable by the processing circuitry 412 to perform operations. In some embodiments, the operations include determining that a performance of a connection between the communication device 410 and the information provider 430 via the network 450 fails to meet a threshold value. In additional or alternative embodiments, the operations include transmitting, via the network interface 416, a message to the route predictor 420 indicating that the performance fails to meet the threshold value. In some examples, the message is transmitted toward the information provider 430. In additional or alternative embodiments, the operations include receiving, via the network interface 416, a message from the route predictor 420 including instructions to improve the performance of the connection.

In this example, the route predictor 420 includes processing circuitry 422, memory 424, and a network interface 426. The memory 424 can include instructions that are executable by the processing circuitry 422 to perform operations. In some embodiments, the operations include receiving information associated with a performance of the network 450 in connecting the communication device 410 and the information provider 430.

In this example, the information provider 430 includes processing circuitry 432, memory 434, and a network interface 436. The memory 434 can include instructions that are executable by the processing circuitry 432 to perform operations.

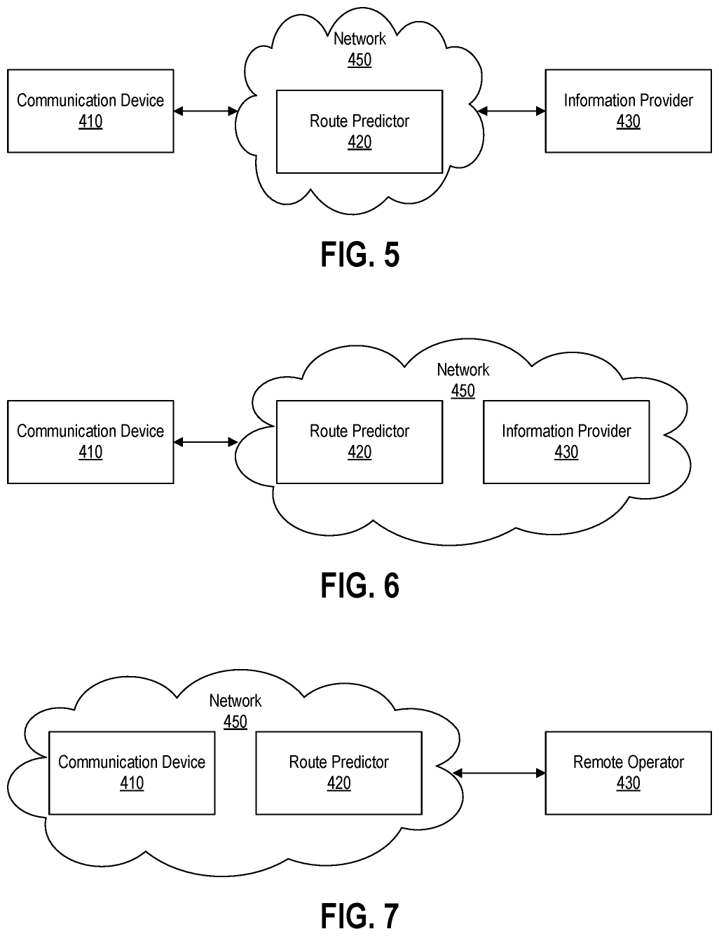

FIG. 5 illustrates an example of the system in which the network 450 includes the route predictor 420.

FIG. 6 illustrates an example of the system in which the network 450 includes the route predictor 420 and information provider 430.

FIG. 7 illustrates an example of the system in which the network 450 includes the communication device 410 and the route predictor 420.

In some embodiments, an AV/ROV will detect intent dissatisfaction, and send “Intent dissatisfaction” reports to a designated destination. The “route predictor” (e.g., route predictor 420 of FIG. 4) can be the destination for these “intent dissatisfaction” reports. In some examples, an intent dissatisfaction report is generated and transmitted in response to actual (e.g., measured) performance falling below a threshold value (e.g., in response to a measured round trip time (“RTT”) being greater than a RTT window). These intent dissatisfaction reports can include raw AV/ROV information including intent violation (e.g., round trip time latency or uplink throughput), location, speed, and time. These intent dissatisfaction reports can also include radio modem information including an indication of a CSP (e.g., public land mobile network (“PLMN”) identifier (“ID”)), a CellID, an evolved universal terrestrial radio access absolute radio frequency channel number (“EUARFCN”) (e.g., a frequency used by the AV/ROV), a reference signal received power (“RSRP”) (e.g., signal strength), a signal-to-noise ratio (“SNR”), and a reference signal received quality (“RSRQ”). In some examples, where historical network information is available to the route predictor, this AV/ROV-sourced data may be considered a source of real-time updates. In cases where network information is not available, for example when and where UE are roaming, this AV/ROV-sourced data may be all the route predictor has to work with. Following this implementation, the route predictor will benefit from network AND AV/ROV data.

In additional or alternative embodiments, the route predictor can subscribe to and ingest network data (e.g., call trace record (“CTR”) data, fault management (“FM”) data, or performance measurement (“PM”) data).

In some examples, the route predictor can subscribe to real-time CTR data from the network. This subscription can instantiate tracing for calls made by an AV/ROV. This trace data can include in-call/in-route network connectivity details including serving cell ID, uplink, and downlink packet flow statistics, serving and neighbor downlink signal strength (e.g., RSRP), channel quality indicator (“CQI”), uplink power headroom, uplink receive signal strength indicator (“RSSI”), uplink signal-to-interference-plus-noise ratio (“SINR”), and radio link failures. Once subscribed, trace data can stream from the network to the route predictor for the duration of each AV/ROV call. CTR measurements and statistics can be compared to intent satisfaction thresholds.

In additional or alternative examples, the route predictor can subscribe to real-time FM (fault management) reports from the network. This subscription can instantiate a flow of FM event alarms including radio, cell site, and transport network service-impacting events. FM events, labeled by associated network elements, can be compared to the in-service network nodes contained in in-progress and new route connectivity predictions.

In additional or alternative examples, the route predictor can subscribe to cell and cell site level PM data reports which are typically aggregated at 15 minute intervals. In the AV/ROV case, the route predictor can receive and process PM data associated with cells and cell sites serving ultra reliable, low latency communications (“URLLC”) network slices. Example PM statistics can include URLLC slice uplink and downlink throughput distribution, latency, downlink RSRP, and uplink RSSI. PM statistics, labeled by associated network elements, can be compared to baselines included in in-progress and new route connectivity predictions.

In additional or alternative embodiments, data received from the AV/ROV may be given greater weight than the network data.

In some embodiments, the area between an origin and a destination of a physical route can be split into labeled grids of 10×10 to 30×30 meters, and groups of these labeled grids can be associated with overlaid road segments.

In some examples, each “intent dissatisfaction” report can include global positioning system (“GPS”) coordinates that fall within one of these labeled grids. The measurements within each of these “intent satisfaction” reports, including intent violation, speed, time, PLMN ID (CSP), CellID, EUARFCN and RSRP, can be associated with the nearest labeled grid.

In additional or alternative examples, each CTR, FM and PM report can include cell and cell site nodes with predicted and/or measured coverage within one of these labeled grids. The measurements, labeled by cell and cell site, can be associated with the nearest labeled grid. Following this association, each labeled grid shall contain a mix of network-sourced

historical data and predictions, AV/ROV reported data, and real-time network CTR, FM, and PM data.

In additional or alternative embodiments, the contents of each “intent dissatisfaction” report can be used as input features for a classification function, which estimates the permanence of the network condition(s) that led to such dissatisfaction. In some examples, “intent dissatisfaction reports” with low RSRP can be logically classified as “permanent”, since radio network coverage is determined by factors that do not change often. In additional or alternative examples, IDRs with medium to high RSRP are classified as “temporary” with some expiration time because such IDRs are likely a result of, for example, variable loading and interference factors that may be classified as temporary.

In additional or alternative embodiments, CTR, FM, and PM data can be used as input features for the classification function. In some examples, PM with low RSRP and no FM alarms are logically classified as “permanent”, since radio network coverage is determined by factors which do not change often. In additional or alternative examples, CTR and PM with low RSRP, at a cell or cell site with a service impacting FM alarm condition, may be classified as “temporary” with some expiration time.

In some examples, this permanence classification can be used for action and model process decisions described below.

In additional or alternative embodiments, when a single-SIM AV/ROV sends “intent dissatisfaction” reports, they are entering, or already within, locations with poor connectivity. If these vehicles remain in such areas, they are likely to lose connection to the operator, stop moving, and/or get in an accident. In some examples, the prediction service will search for, and recommend, alternate connected road segments with better predicted performance and fewer and/or less severe “intent satisfaction” reports.

In some examples, severity for a specific road segment can be measured by a spatial statistics (e.g., a percentage of a segment area with intent dissatisfaction). Historical variations can be addressed by generating temporal prediction models using historical network data. IDRs can expose spatial and temporal exceptions that are otherwise obscured by relatively static models.

In additional or alternative embodiments, when a single-SIM AV/ROV CTR traces indicate “intent miss” conditions, they are entering, or already within, locations with poor connectivity. If these vehicles remain in such areas, they are likely to lose connection to the operator, stop moving, and/or get in an accident. In this case, the prediction service will search for, and recommend, alternate connected road segments with better predicted performance, fewer and/or less severe “intent miss” conditions.

In additional or alternative embodiments, PM data is slowly aggregated for all communication devices (sometimes referred to herein as user equipment (“UE”)) served within a time interval (e.g., 15 minutes). PM data can yield an average/median result.

In additional or alternative embodiments, when multi-SIM AV/ROV send “intent dissatisfaction” reports, they are entering, or already within, locations with poor connectivity for the in-use CSP network (e.g., PLMN). In some examples, the prediction service will search for, and recommend, alternate CSP networks with better predicted performance, fewer and/or less severe “intent satisfaction” reports.

In additional or alternative embodiments, severity for a CSP on a specific road segment can be measured by a spatial statistics (e.g., a percentage of a segment area with intent dissatisfaction). CSP comparisons and decisions can be made on a road segment basis, since this can be the resolution of a routing algorithm. This resolution can enable opportunistic use of two operator cell sites which may, for example, be interleaved on opposite towers or rooftops on opposite blocks, and possibly have better coverage on interleaved road segments.

As explained above, new “intent dissatisfaction” report data (or new “intent miss” condition data) can be associated with labeled grids and associated road segments. In some embodiments, trailing AV/ROV may have been prescribed the same physical route and road segments as the leading AV/ROV that recently encountered and reported “intent dissatisfaction” for a specific labeled grid and road segment. In some examples, if the “intent dissatisfaction” report has not expired, the prediction service can search for, and recommend, an alternate physical route (e.g., for a single SIM AV/ROV) or CSP (e.g., for a multi-SIM AV/ROV) for the in-route trailing AV/ROV before the trailing AV/ROV enters the degraded labeled grid and road segment.

In some examples, from a connectivity perspective, an recommending an alternate physical route is prioritized over recommending an alternate CSP.

In additional or alternative embodiments, additional trailing AV/ROV will require route guidance before departure. In some examples, if the “intent dissatisfaction” report (or new “intent miss” condition data) has not expired, then the associated labeled grid and road segment shall be classified as “restricted.” The prediction service can find and recommend alternate road segments, without active “intent dissatisfaction.” If no alternate physical route is available, the prediction service can recommend a planned, location-based, switch from one CSP to another with better connectivity or delaying departure until after the “intent dissatisfaction” report has expired.

In additional or alternative embodiments, if the “intent dissatisfaction” (or new “intent miss” condition data) report is classified as “permanent”, for example due to low RSRP, then the prediction service shall update the associated labeled grid and road segment prediction model with low coverage and QoS. In some examples, subsequent predictions and route recommendations will avoid this labeled grid and associated road segment unless and until there is some reason, for example new cell site construction.

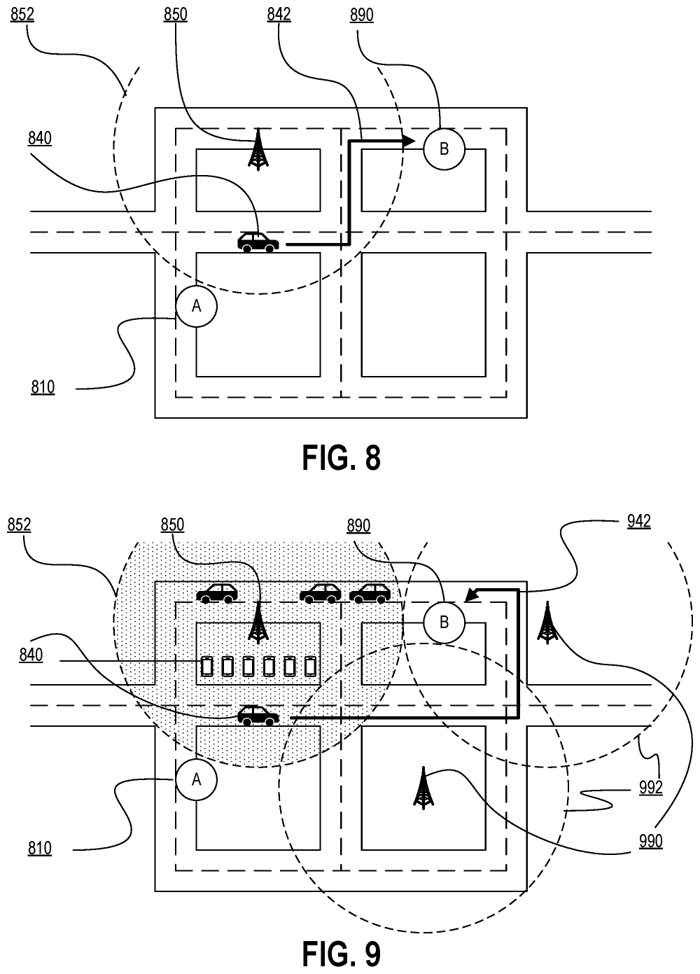

FIGS. 8-10 illustrate examples of adjusting a physical route to a physical destination in order to improve a connection of a ROV moving (or planning to move) along the physical route.

FIG. 8 illustrates an example of a ROV 840 traveling along a physical route 842 from point A 810 to point B 890. The ROV 840 is connected to a communication network by a cell 852 provided by network node 850. In some examples, the ROV includes a camera that transmits a video signal via the network node 850 to a remote operator, which transmits control signals back to the ROV via the network node 850.

FIG. 9 illustrates a further example of the ROV 840 moving between point A 810 to point B 890. However, the ROV 840 has adjusted from physical route 842 to physical route 942. In some examples, this adjustment is made in response to performance issues with cell 852 and/or network node 850. As illustrated, several other vehicles and communication devices are in cell 852, which may be causing a reduction in a performance of the connection between the ROV 840 and a remote operator via the network node 850. The new physical route 942 may be a longer distance than physical route 842, however, it allows the ROV 840 to connect to the remote operator via cells 992 and network nodes 990, which may have better performance than cell 852 and network node 852. In this example, a longer path with a better network connection is determined to be more important than a shorter path with a less reliable network connection.

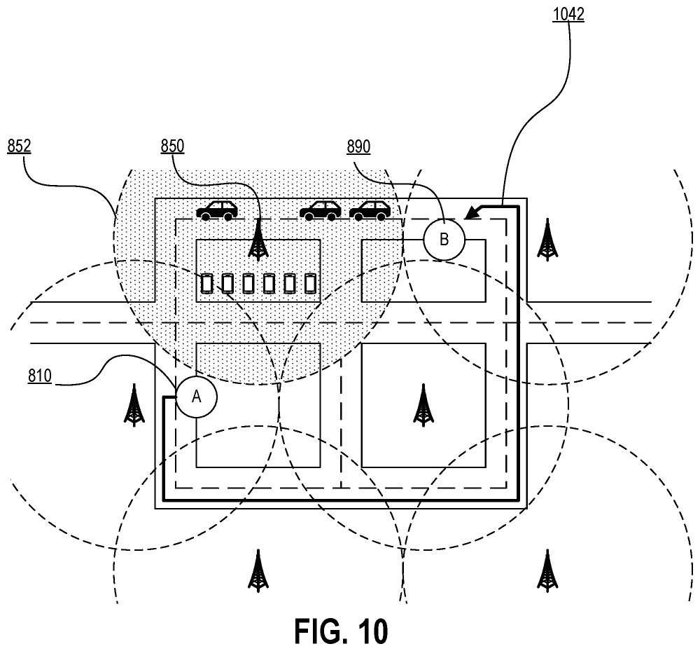

FIG. 10 illustrates an example of another physical route 1042, which may be provided to other vehicles that had planned to travel along physical route 842 (or a segment of physical route 842). In some examples, a route predictor provides this additional physical route 1042 to other vehicles in response to ROV 840 adjusting its physical route and/or in response to ROV 840 experiencing performance issues along physical route 842.

In additional or alternative embodiments, the innovations are applicable with any suitable communication device moving along a physical route. In some examples, the communication device can be a mobile phone being carried by a runner or a bike rider. In additional or alternative examples, the communication device can be part of a bus, boat, drone, or plane. The term “physical route” can be used herein to refer to a real world path between a first point and a second point. In this example, a physical route includes one or more roads. In additional or alternative examples, a physical route includes a path through a sky, a body of water, or a warehouse floor.

Although FIGS. 8-10 illustrate adjusting the physical route to improve a connection between the ROV and a remote operator, in additional or alternative embodiments, the ROV can adjust characteristics of the connection (e.g., radio access technologies, network providers, or cells used to communicate with the remote operator).

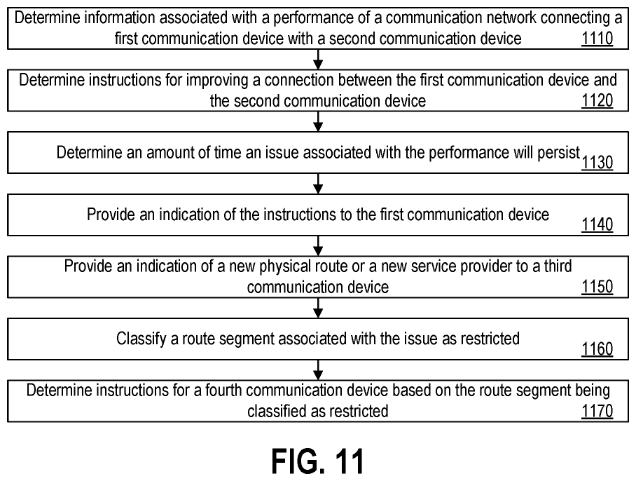

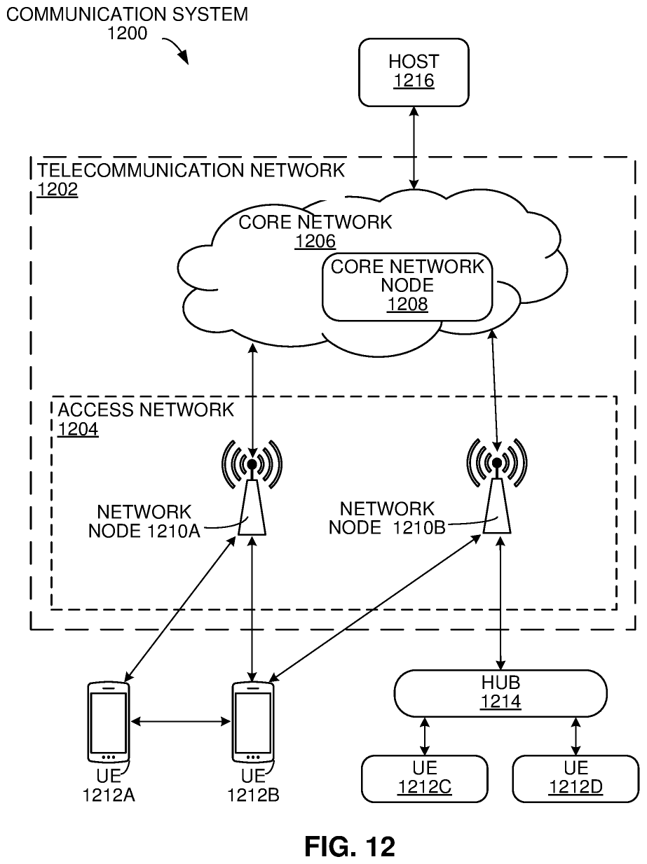

In the description that follows, while the system may be any of the communication system 1200, telecommunication network 1202, the route predictor 420, network node 1210A, 1210B, core network node 1208, network node 1400, virtualization hardware 1604, virtual machines 1608A, 1608B, network node 1704, communication device 410, wireless device 1212A, 1212B, wired or wireless devices UE 1212C, UE 1212D, UE 1300, virtualization hardware 1604, virtual machines 1608A, 1608B, or UE 1706, the communication system 1200 shall be used to describe the functionality of the operations of the network node. Operations of the communication system 1200 (implemented using the structure of the block diagram of FIG. 12) will now be discussed with reference to the flow charts of FIG. 11 according to some embodiments of inventive concepts. For example, modules may be stored in memory of core network node 1208, network nodes 1210A-B, or UE 1212A-D, and these modules may provide instructions so that when the instructions of a module are executed by respective processing circuitry, system 1200 performs respective operations of the flow chart.

FIG. 11 illustrates an example of operations performed by a system configured to manage physical routes associated with one or more communication networks.

At block 1110, the system determines information associated with a performance of a communication network connecting a first communication device with a second communication device. In some embodiments, the first communication device can be moving along a physical route.

In additional or alternative embodiments, the system includes the communication network. In some examples, the communication network includes network nodes including at least one radio access network (“RAN”) node configured to communicate with the first communication device.

In additional or alternative embodiments, the system includes at least one of the first communication device; the second communication device; and a route predictor. In some examples, the first communication device includes at least one of: a ROV; an AV; and a navigation device. The second communication device includes at least one of: a remote operator; a content provider; and the route predictor.

In additional or alternative embodiments, determining the information associated with the performance includes receiving, via a RAN node of the communication network, an intent dissatisfaction report including at least one of: an indication of the performance; an indication of a location of the communication device; an indication of a speed of the communication device an indication of a time that that performance was determined; and an indication of radio modem information associated with the communication device.

In some examples, the indication of the performance includes an indication of at least one of: a round trip time (“RTT”) of communication between the first communication device and the second communication device; a throughput of communication between the first communication device and the second communication device; and a flow interruption time of communication between the first communication device and the second communication device;

In additional or alternative examples, the indication of the location of the first communication device includes an indication of a route segment of the physical route in which the first communication device is located.

In additional or alternative examples, the indication of the radio modem information includes an indication of at least one of: a CSP; a PLMN ID; a cell ID; an EUARFCN; a frequency; a SNR; a RSRP; and a RSRQ.

In additional or alternative embodiments, determining the information associated with the performance includes receiving network information from a network node of the communications network. In some examples, the network information includes at least one of: CTR data; FM data; and PM data.

In some examples, the system includes the communication network and the communication network includes at least one CN node configured to generate the network information.

In some examples, the network information is associated with a route segment of the physical route in which the first communication device is located.

At block 1120, the system 1200 determines instructions for improving the connection. In some embodiments, the physical route is a first physical route and determining the instructions for improving the connection includes determining a route segment of a second physical route with a better predicted network performance than a route segment of the first physical route in which the first communication device is currently located.

In additional or alternative embodiments, the communications network is a first communication network and determining the instructions for improving the connection includes determining that using a second communication network will improve the connection.

At block 1130, the system 1200 determines an amount of time an issue associated with the performance will persist. In some embodiments, determining the instructions for improving the connection includes determining the instructions based on the amount of time. At block 1140, the system 1200 provides an indication of the instructions to the first

communication device. In some embodiments, providing the indication of the instructions includes transmitting, via a RAN node, an indication of a second physical route. In additional or alternative embodiments, transmitting, via a RAN node, the indication of the instructions includes transmitting an indication of the second communication network.

At block 1150, the system 1200 provides an indication of a new physical route or a new service provider to a third communication device. In some examples, the third communication device is moving along a physical route that includes a route segment associated with the issue the first communication device is experiencing. In some embodiments, the system transmits, via a RAN node, the new physical route or new service provider to the third communication device based on determining that an amount of time that the issue will persist exceeds a threshold value.

At block 1160, the system 1200 classifies a route segment associated with the issue as restricted. In some embodiments, the route segment is classified based on the amount of time that the issue will persist.

At block 1170, the system 1200 determines instructions for a fourth communication device based on the route segment being classified as restricted. In some examples, the fourth communication device has not yet begun traveling along a physical route. In some embodiments, the instructions for the fourth communication device include at least one of: a fourth physical route that avoids the route segment; a second communication network; and a delay of operation based on the amount of time.

Various operations from the flow chart of FIG. 11 may be optional with respect to some embodiments of systems and related methods.

FIG. 12 shows an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3rd Generation Partnership Project (3GPP) access node or non-3GPP access point. Moreover, as will be appreciated by those of skill in the art, the network nodes 1210 are not necessarily limited to an implementation in which a radio portion and a baseband portion are supplied and integrated by a single vendor. Thus, it will be understood that the network nodes 1210 may include disaggregated implementations or portions thereof. For example, in some embodiments, the telecommunication network 1202 includes one or more Open-RAN (ORAN) network nodes. An ORAN network node is a node in the telecommunication network 1202 that supports an ORAN specification (e.g., a specification published by the O-RAN Alliance, or any similar organization) and may operate alone or together with other nodes to implement one or more functionalities of any node in the telecommunication network 1202, including one or more network nodes 1210 and/or core network nodes 1208.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 1210 facilitate direct or indirect connection of user equipment (UE), such as by connecting wireless devices 1212a, 1212b, 1212c, and 1212d (one or more of which may be generally referred to as UEs 1212) to the core network 1206 over one or more wireless connections. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub-that is, a hub whose primary function is to route communications to/from the UEs from/to the network node 1210b. In other embodiments, the hub 1214 may be a non-dedicated hub-that is, a device which is capable of operating to route communications between the UEs and network node 1210b, but which is additionally capable of operating as a communication start and/or end point for certain data channels.

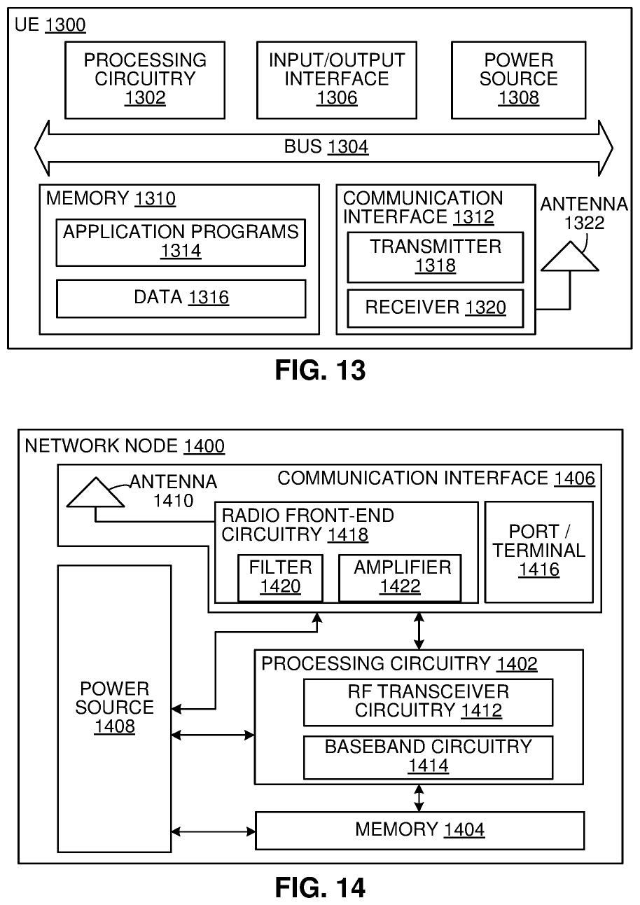

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above.

For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

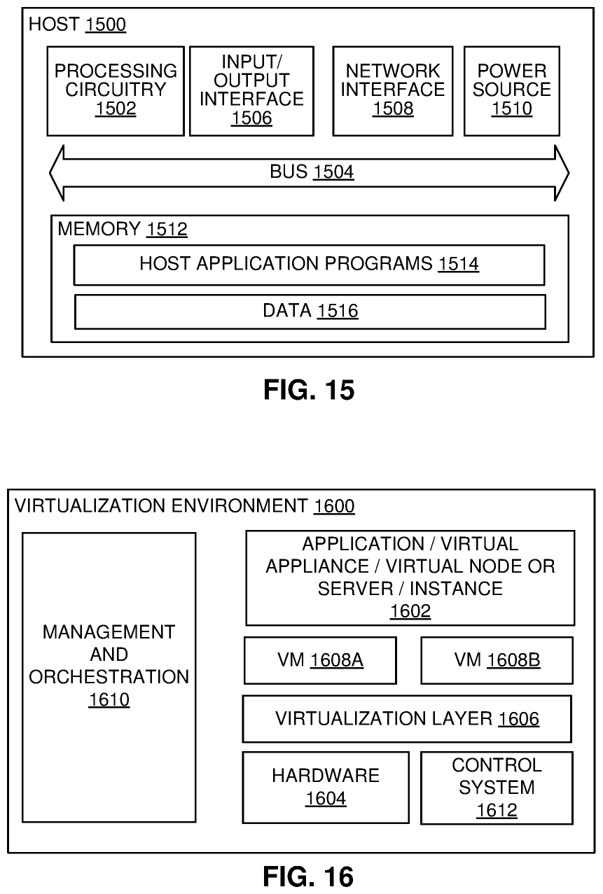

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1600 includes components defined by the O-RAN Alliance, such as an O-Cloud environment orchestrated by a Service Management and Orchestration Framework via an O-2 interface.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

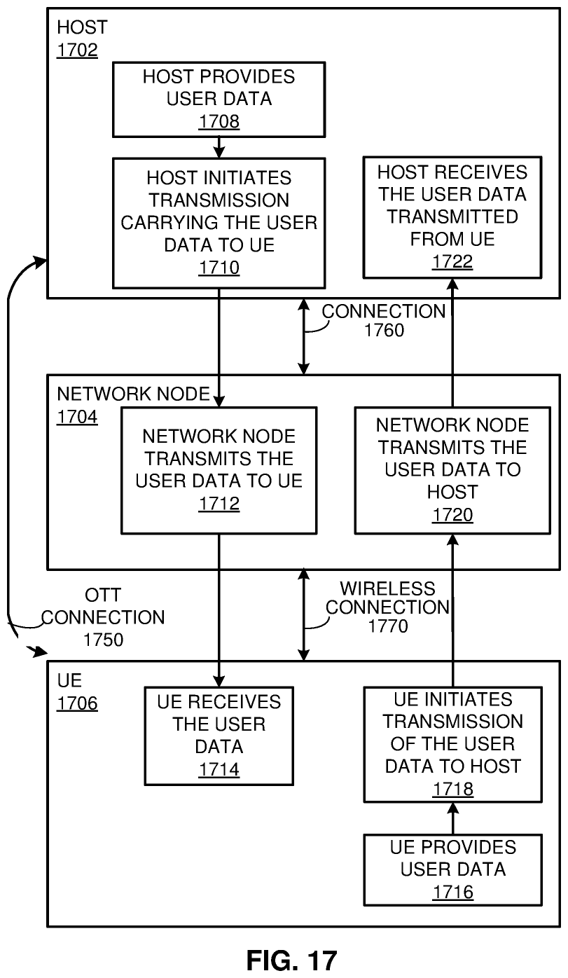

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, the teachings of these embodiments may reduce the risk of lost connectivity (and/or insufficient connectivity) for communication devices moving along a route. In some embodiments, the risk of lost connectivity is reduced without dependence on massive radio network capacity and/or coverage and data feed upgrades. Additional or alternative embodiments are able to improve connectivity reliability, even in multi-CSP network and multi-SIM AV/ROV scenarios where network performance data, predictions, and control are sparse or unavailable. Additional or alternative embodiments are aware of, and adaptive to, real-world and real-time connectivity issues which may not be predictable. Additional or alternative embodiments leverage distributed data sources and processing, and shall therefore improve with AV/ROV number and range expansion.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality.

The benefits provided by such functionality are not limited to the processing circuitry alone or to other components of the computing device, but are enjoyed by the computing device as a whole, and/or by end users and a wireless network generally.

1. A method of operating a system configured to manage physical routes associated with one or more communication devices, the method comprising:
determining information associated with a performance of a first communication network connecting a first communication device with a second communication device as the first communication device moves along a physical route;
responsive to determining the information, determining instructions for improving a connection between the first communication device and the second communication device;
determining an amount of time an issue associated with the performance will persist, determining the instructions for improving the connection comprising determining the instructions based on the amount of time;
providing an indication of the instructions to the first communication device;
responsive to the amount of time exceeding a threshold value, providing an indication of a new physical route or a new service provider to a third communication device moving along a third physical route that included a route segment associated with the issue, the threshold value being a first threshold value;
responsive to the amount of time exceeding a second threshold value, classifying a route segment associated with the issue as restricted;
subsequent to classifying the route segment as restricted and prior to the amount of time elapsing, determining instructions for a fourth communication device based on the route segment being classified as restricted, the physical route being a first physical route;
determining the instructions for improving the connection comprising determining a route segment of a second physical route with a better predicted network performance than a route segment of the first physical route in which the first communication device is currently located;
providing the indication of the instructions comprises providing an indication of the second physical route;
determining the instructions for improving the connection comprising determining that using a second communication network will improve the connection; and
providing the indication of the instructions comprising providing an indication of the second communication network.

2. The method of claim 1, wherein the system comprises the first communication network, and wherein the communication network comprises a plurality of network nodes including at least one radio access network, RAN, node configured to communicate with the first communication device.

3. The method of claim 1, wherein determining the information associated with the performance comprises receiving, via a RAN node of the first communication network an intent dissatisfaction report including at least one of:
an indication of the performance;
an indication of a location of the communication device;
an indication of a speed of the communication device;
an indication of a time that that performance was determined; and
an indication of radio modem information associated with the communication device.

4. The method of claim 3, wherein the indication of the performance comprises an indication of at least one of:
a round trip time, RTT, of communication between the first communication device and the second communication device;
a throughput of communication between the first communication device and the second communication device; and
a flow interruption time of communication between the first communication device and the second communication device.

5. The method of claim 1, wherein the indication of the location of the first communication device comprises an indication of a route segment of the physical route in which the first communication device is located.

6. The method of claim 1, wherein the indication of the radio modem information comprises an indication of at least one of:
a communication service provider, CSP;
a public land mobile network, PLMN, identifier, ID;
a cell ID;
an evolved universal terrestrial radio access absolute radio frequency channel number, EUARFCN;
a frequency;
a signal-to-noise ratio, SNR;
a reference signal received power, RSRP; and
a reference signal received quality, RSRQ.

7. The method of claim 1, wherein the network information includes at least one of:
call trace record, CTR, data;
fault management, FM, data; and
performance measurement, PM, data.

8. The method of claim 7, wherein the system comprises the first communication network, and wherein the first communication network comprises a plurality of network nodes including at least one core network, CN, node configured to generate the network information.

9. The method of claim 7, wherein the network information is associated with a route segment of the physical route in which the first communication device is located.

10-14. (canceled)

15. The method of claim 1, wherein the instructions for the fourth communication device comprises an indication of at least one of:
a fourth physical route that avoids the route segment;
the second communication network; and
a delay of operation based on the amount of time.

16. The method of claim 1, wherein the system comprises at least one of:
the first communication device;
the second communication device; and
a route predictor.

17. The method of claim 1, wherein the first communication device comprises at least one of:
a remotely operated vehicle, ROV;
an autonomous vehicle; and
a navigation device; and
wherein the second communication device comprises at least one of:
a remote operator;
a content provider; and
a route predictor.

18. A system for managing physical routes associated with one or more communication devices, the system comprising:
processing circuitry; and
memory coupled to the processing circuitry and having instructions stored therein that are executable by the processing circuitry to cause the system to:
determine information associated with a performance of a first communication network connecting a first communication device with a second communication device as the first communication device moves along a physical route;
responsive to determining the information, determine instructions for improving a connection between the first communication device and the second communication device;
determine an amount of time an issue associated with the performance will persist, determining the instructions for improving the connection comprising determining the instructions based on the amount of time;
provide an indication of the instructions to the first communication device;
responsive to the amount of time exceeding a threshold value, provide an indication of a new physical route or a new service provider to a third communication device moving along a third physical route that included a route segment associated with the issue, the threshold value being a first threshold value;
responsive to the amount of time exceeding a second threshold value, classify a route segment associated with the issue as restricted;
subsequent to classifying the route segment as restricted and prior to the amount of time elapsing, determine instructions for a fourth communication device based on the route segment being classified as restricted, the physical route being a first physical route;
determining the instructions for improving the connection comprising determining a route segment of a second physical route with a better predicted network performance than a route segment of the first physical route in which the first communication device is currently located;
providing the indication of the instructions comprises providing an indication of the second physical route;
determining the instructions for improving the connection comprising determining that using a second communication network will improve the connection; and
providing the indication of the instructions comprising providing an indication of the second communication network.

19. (canceled)

20. A non-transitory computer storage medium storing program code to be executed by processing circuitry of a system for managing physical routes associated with one or more communication devices, execution of the program code causing the system to;
determine information associated with a performance of a first communication network connecting a first communication device with a second communication device as the first communication device moves along a physical route;
responsive to determining the information, determine instructions for improving a connection between the first communication device and the second communication device;
determine an amount of time an issue associated with the performance will persist, determining the instructions for improving the connection comprising determining the instructions based on the amount of time;
provide an indication of the instructions to the first communication device;
responsive to the amount of time exceeding a threshold value, provide an indication of a new physical route or a new service provider to a third communication device moving along a third physical route that included a route segment associated with the issue, the threshold value being a first threshold value;
responsive to the amount of time exceeding a second threshold value, classify a route segment associated with the issue as restricted;
subsequent to classifying the route segment as restricted and prior to the amount of time elapsing, determine instructions for a fourth communication device based on the route segment being classified as restricted, the physical route being a first physical route;
determining the instructions for improving the connection comprising determining a route segment of a second physical route with a better predicted network performance than a route segment of the first physical route in which the first communication device is currently located;
providing the indication of the instructions comprises providing an indication of the second physical route;
determining the instructions for improving the connection comprising determining that using a second communication network will improve the connection; and
providing the indication of the instructions comprising providing an indication of the second communication network.

21. (canceled)

22. The method of claim 2, wherein determining the information associated with the performance comprises receiving, via a RAN node of the first communication network an intent dissatisfaction report including at least one of:
an indication of the performance;
an indication of a location of the communication device;
an indication of a speed of the communication device;
an indication of a time that that performance was determined; and
an indication of radio modem information associated with the communication device.

23. The method of claim 22, wherein the indication of the performance comprises an indication of at least one of:
a round trip time, RTT, of communication between the first communication device and the second communication device;
a throughput of communication between the first communication device and the second communication device; and
a flow interruption time of communication between the first communication device and the second communication device.

24. The method of claim 2, wherein the indication of the location of the first communication device comprises an indication of a route segment of the physical route in which the first communication device is located.

25. The method of claim 2, wherein the indication of the radio modem information comprises an indication of at least one of:
a communication service provider, CSP;
a public land mobile network, PLMN, identifier, ID;
a cell ID;
an evolved universal terrestrial radio access absolute radio frequency channel number, EUARFCN;
a frequency;
a signal-to-noise ratio, SNR;
a reference signal received power, RSRP; and
a reference signal received quality, RSRQ.

26. The method of claim 2, wherein the network information includes at least one of:
call trace record, CTR, data;
fault management, FM, data; and
performance measurement, PM, data.

27. The method of claim 26, wherein the system comprises the first communication network, and wherein the first communication network comprises a plurality of network nodes including at least one core network. CN, node configured to generate the network information.
